(19) United States
(12) Patent Application Publication
(10) Pub. No.: US 2018/0241633 A1
(43) Pub. Date: Aug. 23, 2018

(54) MANAGEMENT SYSTEM AND MANAGEMENT METHOD

(71) Applicant: CANON KABUSHIKI KAISHA, Tokyo (JP)

(72) Inventor: Jun Horiyama, Inagi-shi (JP)

(21) Appl. No.: 15/889,790

(22) Filed: Feb. 6, 2018

(30) Foreign Application Priority Data
Feb. 20, 2017 (JP) 2017-028804

(51) Int. Cl. H04L 12/24; H04L 29/08

(52) U.S. Cl. CPC H04L 41/12; H04L 67/12

(57) ABSTRACT

A management system including one or more electronic apparatuses connected to a predetermined network and an information processing apparatus configured to collect operational data concerning each of the electronic apparatuses is provided. The information processing apparatus makes a request to acquire operational data from the electronic apparatus functioning as a node device of a mesh network different from the predetermined network via the mesh network. Moreover, the information processing apparatus collects operational data of a node device transmitted in response to the request.

### BACKGROUND OF THE INVENTION

### Field of the Invention

The present invention relates to a management system and a management method.

### Description of the Related Art

In order to ascertain use states of a plurality of network devices installed in an office, a system to which a dedicated server configured to collect operational data of the network devices is applied has been proposed. For example, there is a system in which a dedicated server configured to collect the number of printed sheets or electric power consumption data is installed in a customer's backbone network environment and a use state of an image forming apparatus serving as an example of a network device is ascertained. Japanese Patent Laid-Open No. 2012-168018 discloses a management system in which an energy management server is installed in an office local area network (LAN) environment and electric power consumption is collected via a LAN cable.

When the management system disclosed in Japanese Patent Laid-Open No. 2012-168018 is constructed, it is assumed that the dedicated server is installed in the office LAN environment. In such an environment, when a dedicated server cannot be connected to a backbone network in an office or cannot be used in view of security, it is difficult to ascertain a use state of a network device in the office.

### SUMMARY OF THE INVENTION

The present invention provides a management system configured to enable operational data of an electronic apparatus connected to a predetermined network to be collected without installing a dedicated server.

A management system according to an embodiment of the present invention includes one or more electronic apparatuses connected to a predetermined network and an information processing apparatus configured to collect operational data concerning each of the electronic apparatuses. The information processing apparatus comprises a first memory storing instructions and a first processor which is capable of executing the instructions in the first memory causing the client apparatus to: request acquisition of operational data from the electronic apparatus functioning as a node device of a mesh network different from the predetermined network via the mesh network; and collect operational data of a node device transmitted in response to the request.

Further features of the present invention will become apparent from the following description of exemplary embodiments (with reference to the attached drawings).

### BRIEF DESCRIPTION OF THE DRAWINGS

FIG. 1 is a diagram showing a configuration of a management system according to an embodiment.

FIG. 2 is a diagram illustrating an example of a configuration of an image forming apparatus.

FIGS. 3A and 3B are diagrams showing a configuration of hardware of a mobile terminal and a smart meter.

FIG. 4 is a diagram for describing a configuration of a software module of the image forming apparatus

FIG. 5 is an example of a functional block diagram of the mobile terminal.

FIG. 6 is a diagram for describing a process of collecting and displaying network traffic information.

FIGS. 7A and 7B are diagrams for describing a process of collecting network traffic information using a leader device and a router device.

FIG. 8 is a flowchart for describing an example of a process of constructing a mesh network.

FIGS. 9A and 9B are diagrams illustrating an example of network traffic information.

FIG. 10 is an example of a graph display of an aggregation result of network traffic information.

FIG. 11 is a flowchart for describing a process of collecting electric power consumption and a process of displaying a graph.

FIGS. 12A and 12B are flowcharts for describing a process of collecting electric power consumption using the leader device and the router device.

FIGS. 13A and 13B are diagram illustrating an example of electric power consumption.

FIGS. 14A and 14B are an example for describing a graph display of an aggregation result of electric power consumption.

### DESCRIPTION OF THE EMBODIMENTS

### First Embodiment

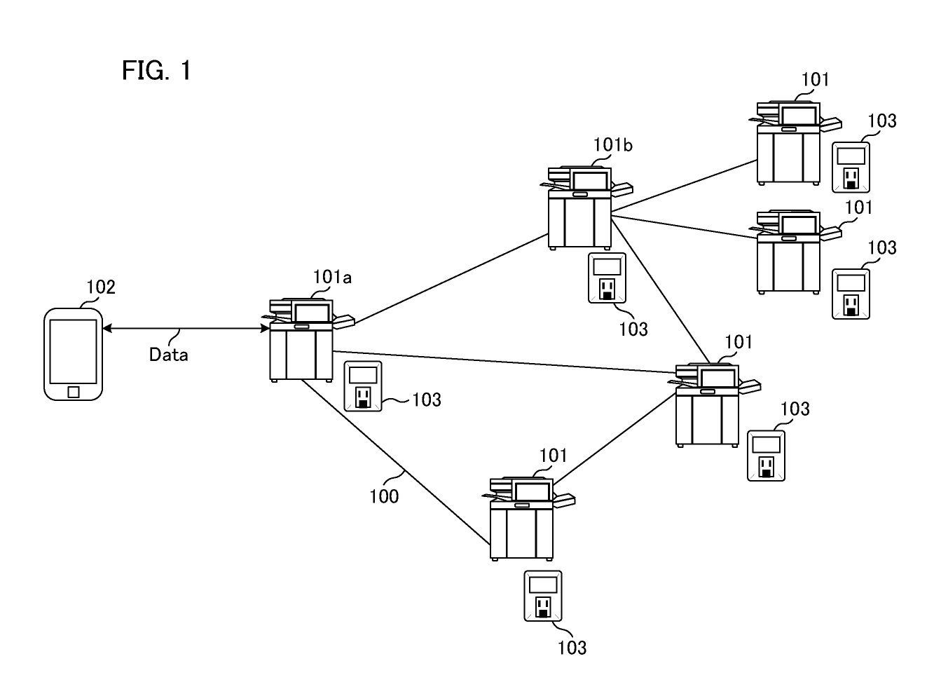

FIG. 1 is a diagram showing a configuration of a management system according to an embodiment.

A management system illustrated in FIG. 1 includes an image forming apparatus 101 serving as an example of a network device, a mobile terminal 102, and a smart meter 103. The present invention is applicable not only to an image forming apparatus (an image processing apparatus) but also to one or more electronic apparatuses capable of transmitting operational data using wireless communication technology such as digital medical apparatuses, network cameras, home electric appliances, or digital health instruments. The image forming apparatus 101a configured to collect operational data concerning such electronic apparatuses is an information processing apparatus according to the embodiment. The information processing apparatus may function as a part of an electronic apparatus. In the following description, the image forming apparatuses 101a and 101b are also simply described as the image forming apparatus 101 in some cases.

A plurality of image forming apparatuses 101 are connected to a predetermined network like a backbone network (not shown) through which a print job or the like passes. A network 100 shown in FIG. 1 is a different network from the above-described predetermined network. The network 100 is, for example, a mesh network using a wireless communication standard (IEEE 802.15.4). In the embodiment, the image forming apparatus 101 functions as a node device of the mesh network. The network 100 allows data communication between the image forming apparatuses 101.

The image forming apparatus 101a is a leader device and ascertains a route through which all image forming apparatuses in the same group on the mesh network communicate with each other. The leader device performs a request for acquiring operational data from the image forming apparatuses on the mesh network and collects the operational data transmitted in response to the request. The leader device collects at least network traffic information or electric power consumption information (electric power consumption) as operational data. The image forming apparatus 101b is a router device and ascertains network traffic information (the number of packets or a packet size) of the image forming apparatuses 101 (hereinafter referred to as an “end device”) present at a lower-ordered node than the image forming apparatus 101b. Note that, although the network 100 according to the embodiment has been described on the assumption that a network for data communication uses the mesh network, the network 100 is not limited to the mesh network.

The image forming apparatuses 101 is a multi-function printer obtained by integrating a plurality of functions such as a scanner, a printer, a facsimile, and a file transmission function with a copier. Furthermore, the image forming apparatuses 101 includes a network interface connected to the mobile terminal 102. Although a type of interface configured to connect the mobile terminal 102 is not limited, data can be read and written through a wireless network interface in the embodiment.

The smart meter 103 is a power supply management apparatus connected to an electrical outlet (not shown) of the image forming apparatuses 101 and configured to manage electric power supply to the image forming apparatuses 101 such as measuring electric power consumption. Furthermore, the smart meter 103 can be connected to the network 100 as the mesh network and can transmit and receive data of electric power consumption or the like through the mesh network.

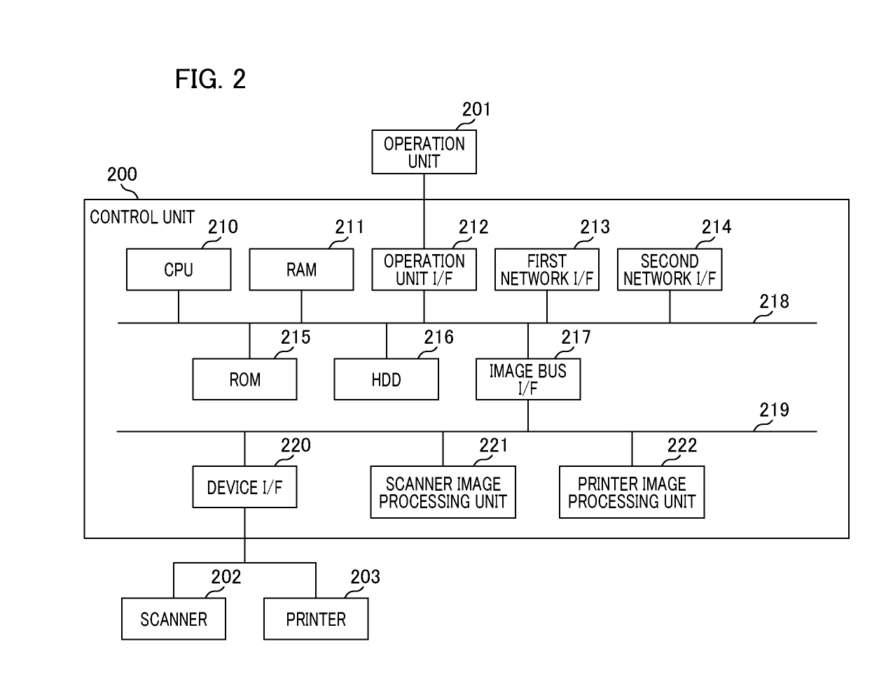

FIG. 2 is a diagram illustrating an example of a configuration of the image forming apparatus shown in FIG. 1.

The image forming apparatuses 101 includes a control unit 200, an operation unit 201, a scanner 202, and a printer 203. The control unit 200 includes a CPU 210, a RAM 211, an operation unit interface (I/F) 212, a first network I/F 213, and a second network I/F 214 as processing units associated with the operation unit. Furthermore, the control unit 200 includes a ROM 215, an HDD 216, an image bus I/F 217, and a system bus 218. “CPU” is an abbreviation for “central processing unit.” “RAM” is an abbreviation for “random access memory.” “ROM” is an abbreviation for “read only memory.” “HDD” is an abbreviation for “hard disk drive.”

The control unit 200 includes an image bus 219, a device I/F 220, a scanner image processing unit 221, and a printer image processing unit 222 as processing units associated with printing and scanning. Note that each of the image forming apparatuses 101 may include the scanner 202 and the scanner image processing unit 221 as necessary.

The CPU 210 is a controller configured to control the entire control unit 200. The RAM 211 is a memory configured to temporarily store image data or processing necessary for an operation of software. The operation unit I/F 212 is an interface with the operation unit 201 and outputs image data displayed in the operation unit 201 to the operation unit 201. Furthermore, information input by a user through the operation unit 201 is transmitted to the CPU 210 through the operation unit I/F 212.

The first network I/F 213 is connected to a predetermined network different from the network 100 as the mesh network, like, for example, the backbone network (not shown). The backbone network is, for example, a network through which a print job or various communication data in a customer's place passes. Note that such a network connectable to the first network I/F 213 may be wired or wireless communication.

The second network I/F 214 is connected to the network 100 as the mesh network. The second network I/F 214 exchanges information with an external apparatus using wireless communication via the network 100. The second network I/F 214 corresponds to, for example, Bluetooth (registered trademark) or the like serving as one wireless communication standard. Furthermore, an external apparatus is, for example, an image forming apparatus 101 or a mobile terminal 102 other than its own apparatus.

The ROM 215 is a boot ROM and stores a boot program of the system. The HDD 216 is an external storage apparatus and stores system software, image data, setting information, or the like. The image bus I/F 217 connects the system bus 218 and the image bus 219 and is a bus bridge configured to perform data conversion. The system bus 218 is a common data exchange path between components constituting the control unit 200.

The image bus 219 is constituted of a peripheral component interconnect (PCI) bus or IEEE 1394. An image bus is a path configured to transfer image data at a high speed. The device I/F 220 connects the scanner 202 and the printer 203, which are image input/output apparatuses, and the control unit 200 and performs synchronous/asynchronous conversion on image data. The scanner image processing unit 221 performs correction, processing, or editing on an input image. The printer image processing unit 222 performs correction, conversion of resolution, or the like according to the performance of the printer on print output image data. Note that the configuration of hardware shown in FIG. 2 is an example and the number of hardware maybe increased or decreased as necessary. For example, although two network I/Fs are provided in FIG. 2, a plurality of pieces of wired communication and wireless communication may be provided for the purpose of dividing wired communication and wireless communication.

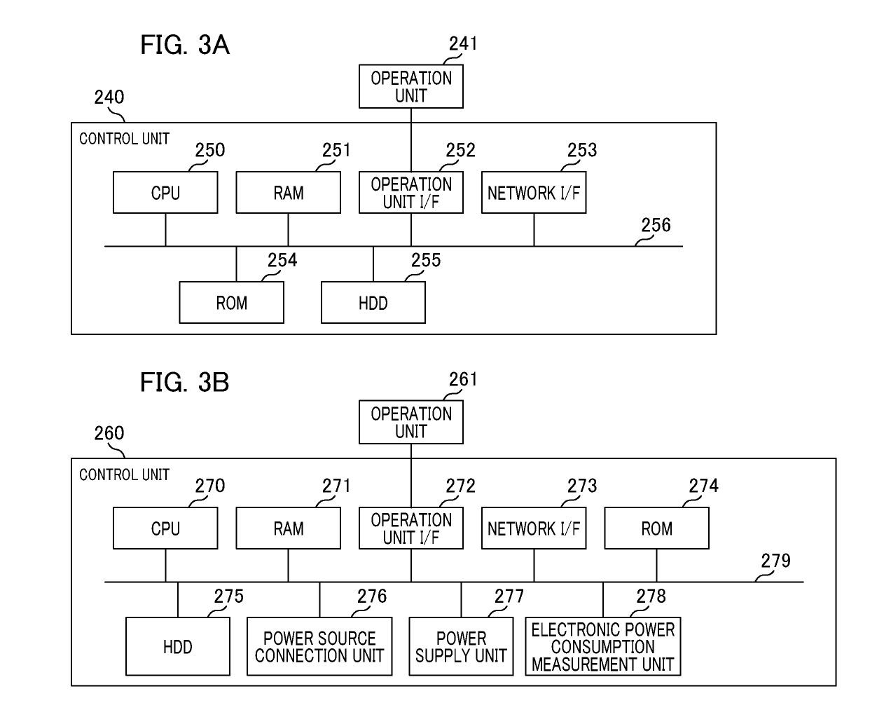

FIGS. 3A and 3B are diagrams illustrating an example of a configuration of hardware of the mobile terminal and the smart meter shown in FIG. 1.

FIG. 3A shows a configuration of hardware of the mobile terminal 102.

The mobile terminal 102 includes a control unit 240 and an operation unit 241. The control unit 240 includes a CPU 250, a RAM 251, an operation unit I/F 252, and a network I/F 253 as processing units associated with the operation unit. Furthermore, the control unit 240 includes a ROM 254, an HDD 255, and a system bus 256. The CPU 250 is a controller configured to control the entire control unit 240. The RAM 251 is a memory configured to temporarily store image data or data necessary for an operation of software. The operation unit I/F 252 is an interface with the operation unit 241 and outputs image data displayed in the operation unit 241 to the operation unit 241. Furthermore, the operation unit I/F 252 transmits information input by the user through the operation unit 241 to the CPU 250. The network I/F 253 is an interface configured to exchange information with an external apparatus using wireless communication. An external apparatus is, for example, the image forming apparatus 101 or the smart meter 103. The ROM 254 is a boot ROM and stores a boot program of the system. The HDD 255 is an external storage apparatus and stores system software, image data, setting information, or the like. The system bus 256 is a common data exchange path between components constituting the control unit 240. Note that a configuration of hardware shown in FIG. 3A is an example and the number of constituent elements may be increased or decreased as necessary.

FIG. 3B shows a configuration of hardware of the smart meter 103.

The smart meter 103 includes a control unit 260 and the operation unit 261. The control unit 260 includes a CPU 270, a RAM 271, an operation unit I/F 272, and a network I/F 273 as processing units associated with the operation unit. Furthermore, the control unit 260 includes a ROM 274, an HDD 275, a power source connection unit 276, a power supply unit 277, an electric power consumption measurement unit 278, and a system bus 279. The CPU 270 is a controller configured to control the entire control unit 260. The RAM 271 is a memory configured to temporarily store electric power consumption data or processing necessary for an operation of software. The operation unit I/F 272 is an interface with the operation unit 261 and outputs image data displayed in the operation unit 261 to the operation unit 261. Furthermore, the operation unit I/F 272 transmits information input by the user through the operation unit 261 to the CPU 270.

The network I/F 273 is an interface configured to exchange information with an external apparatus using wireless communication. An external apparatus is, for example, other smart meter 103, mobile terminal 102, and image forming apparatus 101. In the embodiment, the smart meter 103 can participate in a mesh network to which an image forming apparatus group belongs not only by wirelessly communicating with the image forming apparatus 101 one by one but also by using the network I/F 273. Furthermore, the smart meter 103 can construct a mesh network together with other smart meters using the network I/F 273 and perform data communication.

The ROM 274 is a boot ROM and stores a boot program of the system. The HDD 275 is an external storage apparatus and stores system software, electric power consumption data, setting information, or the like. The power source connection unit 276 is a so-called electric power plug. When the power source connection unit 276 is inserted into the electrical outlet (not shown), energization becomes possible. The power supply unit 277 is a so-called electrical outlet, and energization becomes possible and electric power is supplied when the electrical plug (not shown) is inserted into the power supply unit 277 in a state in which energization is possible. The electric power consumption measurement unit 278 measures an amount of electric power consumed when the electrical plug (not shown) is inserted into the power supply unit 277 and electric power is used. In the embodiment, it is assumed that the electric power consumption measurement unit 278 measures an amount of electric power consumed when the electrical plug (not shown) of the image forming apparatus 101 is inserted into the power supply unit 277 and the image forming apparatus 101 is used. The system bus 279 is a common data exchange path between components constituting the control unit 260. Note that the configuration of hardware shown in FIG. 3B is an example and the number of constituent elements may be increased or decreased as necessary.

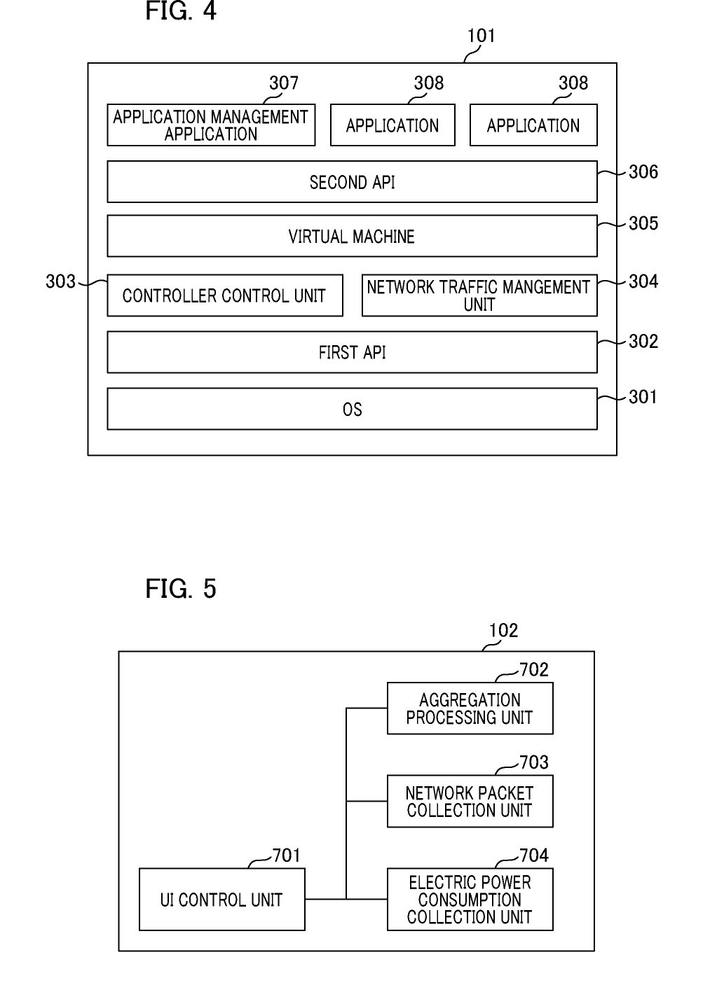

FIG. 4 is a diagram for describing a configuration of a software module of the image forming apparatus.

An OS 301 is an operating system and manages/controls resources of the entire image forming apparatus 101. A first API 302 is an interface for an application operating in the OS 301. An API is an abbreviation for an application programming interface. An application can access resources on the image forming apparatus 101 through the first API or can execute a command with the CPU.

A controller control unit 303 operates on the OS 301 and controls the scanner 202, the printer 203, the operation unit 201, or the like. A network traffic management unit 304 manages a history of a network traffic communicating via the first network I/F 213 and the second network I/F 214. The network traffic management unit 304 makes it possible to transmit the history of the network traffic in response to a request from an application 308.

A virtual machine 305 has an optimum execution environment for executing a specific application and is realized by, for example, a Java (registered trademark) virtual machine or the like. A second API 306 is an interface through which the application operating in the virtual machine 305 uses the controller control unit 303, the network traffic management unit 304, the first API 302, or the like. An application management application 307 manages the application operating in the virtual machine 305. The application management application 307 controls downloading, uploading, erasing, enabling and disabling, or the like of an application. The application 308 is an application operating in the virtual machine 305. In the configuration shown in FIG. 4, any number of applications having arbitrary functions can be appropriately installed and operated in the image forming apparatus 101 as appropriate. Such an application includes an application having an aggregation function. The application having the aggregation function displays an amount of network traffic of a plurality of image forming apparatuses 101, an aggregation of amounts of commercially available electric power, the aggregation result, or the like. A function of each application is realized by storing a corresponding program in the ROM 215 or an HDD unit 216, loading the program in the RAM 211 when the image forming apparatus 101 is activated and executing the program.

FIG. 5 is an example of a functional block of the mobile terminal.

The mobile terminal 102 includes a UI control unit 701, an aggregation processing unit 702, a network packet collection unit 703, and an electric power consumption collection unit 704. System software stored in an HDD 225 (FIG. 3A) realizes the UI control unit 701 to the electric power consumption collection unit 704. The network packet collection unit 703 communicates with the application 308 via the first network I/F 213 or the second network I/F 214 of the image forming apparatus 101 and collects network traffic information.

The electric power consumption collection unit 704 communicates with the application 308 via the first network I/F 213 or the second network I/F 214 of the image forming apparatus 101 and collects electric power consumption. The electric power consumption collection unit 704 collects electric power consumption using, for example, Bluetooth. The aggregation processing unit 702 aggregates the collected network traffic information or electric power consumption. The UI control unit 701 displays the network traffic information or electric power consumption aggregated by the aggregation processing unit 702 on a display unit of the mobile terminal 102. Note that the leader device may collect/aggregate the network traffic information or electric power consumption and transmit the network traffic information or electric power consumption to an external apparatus via a communication line of a small computer involved in the leader device instead of the configuration in which the mobile terminal 102 collects/aggregates the electric power consumption. For example, RasPi (Raspberry Pi) may be applied as the above-described small computer.

### <Network Traffic Information Collection Process>

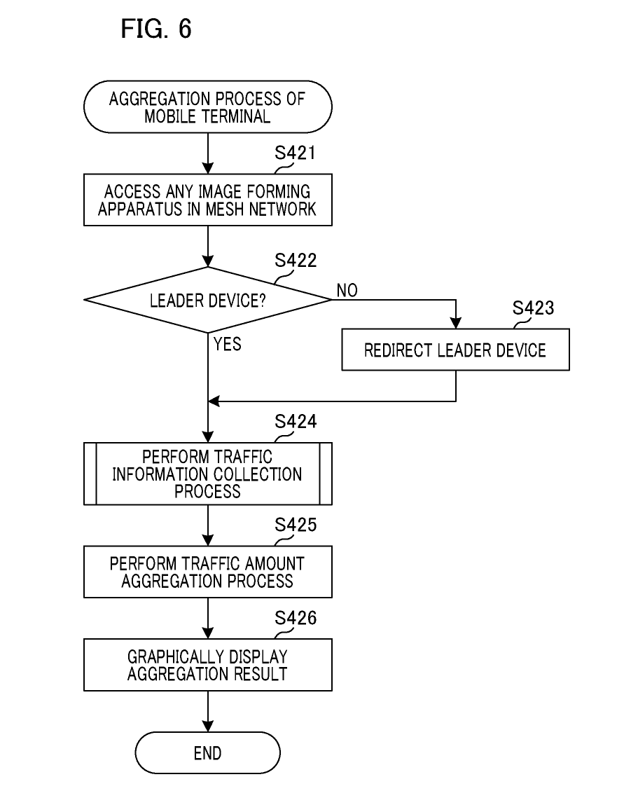

FIG. 6 is a flowchart for describing a network traffic information collection process and a graph display process of a mesh network in a mobile terminal.

The processes illustrated in FIG. 6 are realized using the CPU 250 (FIG. 3A) included in the mobile terminal 102 executing the system software stored in the HDD 255. In S421, the mobile terminal 102 is connected to any of the image forming apparatuses 101 in the mesh network via the second network I/F 214. Subsequently, in S422, the mobile terminal 102 determines whether the connected image forming apparatus 101 is a leader device. When it is determined that the image forming apparatus 101 is the leader device, the process proceeds to a process of S424. When it is determined that the image forming apparatus 101 is not the leader device, the process proceeds to a process of S423. Since the devices in the mesh network recognize a device as a leader device, when it is determined that the image forming apparatus 101 is not the leader device, a communication process is redirected to the leader device.

Subsequently, in S424, the mobile terminal 102 performs the network traffic information collection process. Subsequently, in S425, the mobile terminal 102 aggregates network traffic information. Moreover, in S426, the mobile terminal 102 graphically displays the aggregation result on the display unit.

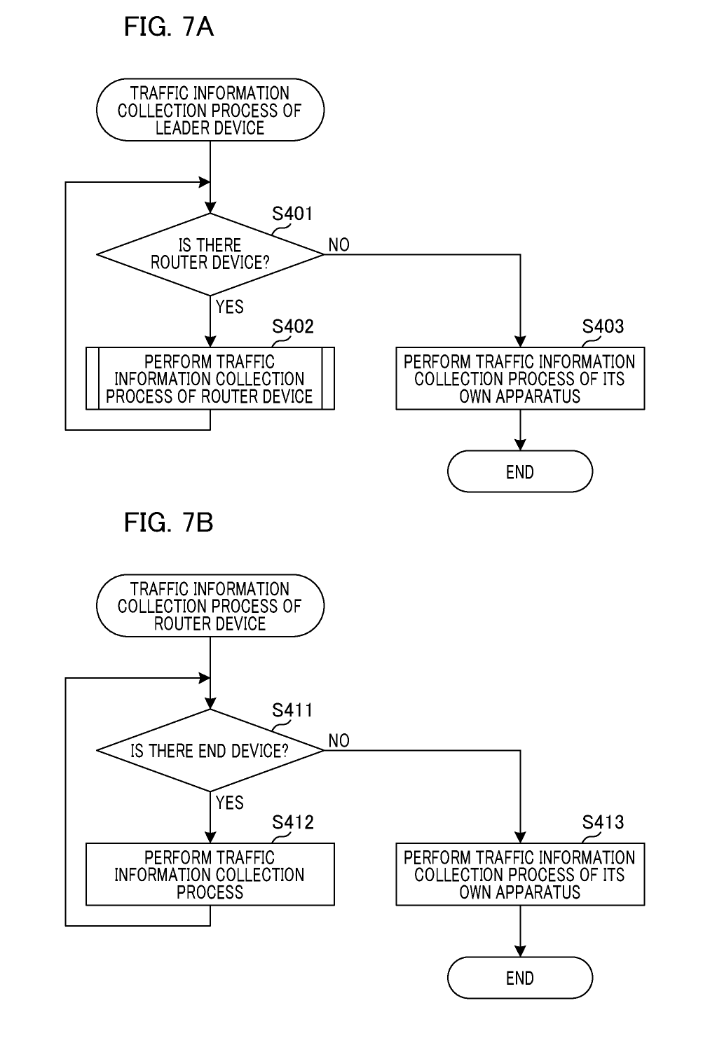

FIGS. 7A and 7B are flowcharts for describing the network traffic information collection process using the leader device and the router device.

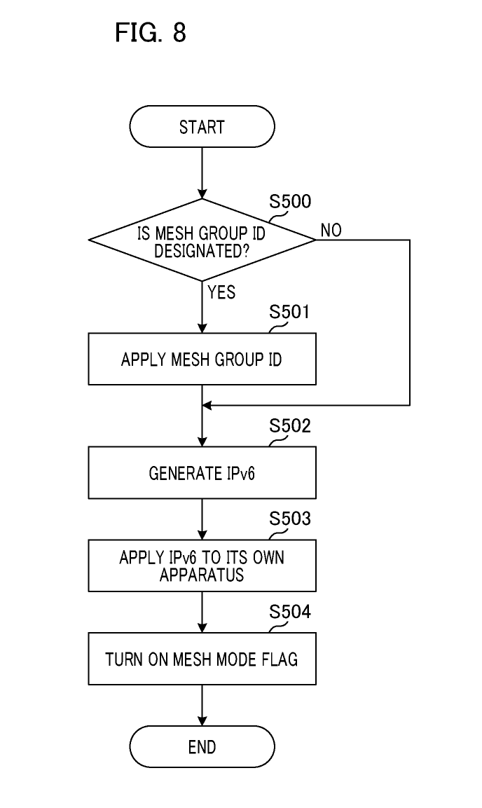

FIG. 7A illustrates the network traffic information collection process using the image forming apparatus 101a serving as the leader device. This process is called from the network traffic information collection process of the mesh network using the mobile terminal 102 in S424 of FIG. 6. Furthermore, the program used to realize this process is stored in the ROM 215 or the HDD unit 216 as the application 308, loaded in the RAM 211 when the image forming apparatus 101 is activated, and executed. A method for constructing the mesh network will be described with reference to FIG. 8 before the contents of this process are described.

FIG. 8 is a flowchart for describing an example of a mesh network construction process.

Each of the image forming apparatuses 101 performs a process of constructing a mesh group with group IDs (mesh group IDs) designated in advance. Each of the group IDs differs, for example, for each type of object data to be collected or for each type of image forming apparatus 101. In S500, the application 308 of the image forming apparatus 101 determines whether a mesh group ID is designated simultaneously with a mesh mode start instruction. In this example, a mesh mode refers to a state in which a mesh network using a wireless communication standard (IEEE 802.15.4) operates. Furthermore, each of the mesh group IDs is, for example, a “PAN ID” defined in IEEE 802.15.4 and an identifier used to group image forming apparatuses to be subjected to installation processing. When it is determined that the mesh group ID is designated, the process proceeds to a process of S501. When it is determined that the mesh group ID is not designated, the process proceeds to a process of S502.

In S501, the application 308 applies the mesh group ID designated simultaneously with the mesh mode start instruction to the image forming apparatus 101. Subsequently, in S502, the application 308 generates an IPv6 address necessary for using the mesh network from a media access control (MAC) address or the like. The application 308 generates an IPv6 address using, for example, a stateless automatic setting.

Subsequently, in S503, the application 308 applies the generated IPv6 address to its own apparatus. Moreover, in S504, the application 308 turns on a flag indicating that its own apparatus is operating in the mesh mode. Note that a flag in which it can be confirmed that the mesh mode is operating is not limited to such a flag, and any flag may be adopted.

The processing described with reference to FIG. 5 is preprocessing for allowing the image forming apparatus 101 to use the mesh network, and all or a part of such processing will be omitted when the image forming apparatus 101 operates in an initial setting. For example, in S504, the mesh network may be made usable only by setting a mesh mode flag. Furthermore, when it is necessary to start the image forming apparatus 101 again to apply the setting of this process, restart processing may be added as necessary.

Description is provided with reference to FIG. 7A again. In S401, the application 308 of the image forming apparatus 101a determines whether a router device is in a mesh network group. When it is determined that the router device is in the mesh network group, the process proceeds to a process of S402. When it is determined that the router device is not in the mesh network group, the process proceeds to a process of S403.

In S402, the application 308 collects network traffic information of the router device. Note that details of the processing contents in S402 will be described below with reference to FIG. 7B. When there are a plurality of router devices, the process is repeated for all router devices. Furthermore, in S403, the application 308 collects network traffic information of the leader device via the network traffic management unit 304. Then, the process ends.

FIG. 7B shows the network traffic information collection process in the image forming apparatus 101b serving as a router device. In S411, the application 308 of the router device determines whether an end device is in the mesh network group. When it is determined that the end device is in the mesh network group, the process proceeds to a process of S412. When it is determined that the end device is not in the mesh network group, the process proceeds to a process of S413.

In S412, the application 308 collects network traffic information of the end device. When there are a plurality of end devices, the process is repeated for all end devices. Furthermore, in S413, the application 308 collects network traffic information of the router device via the network traffic management unit 304. Then, the process ends.

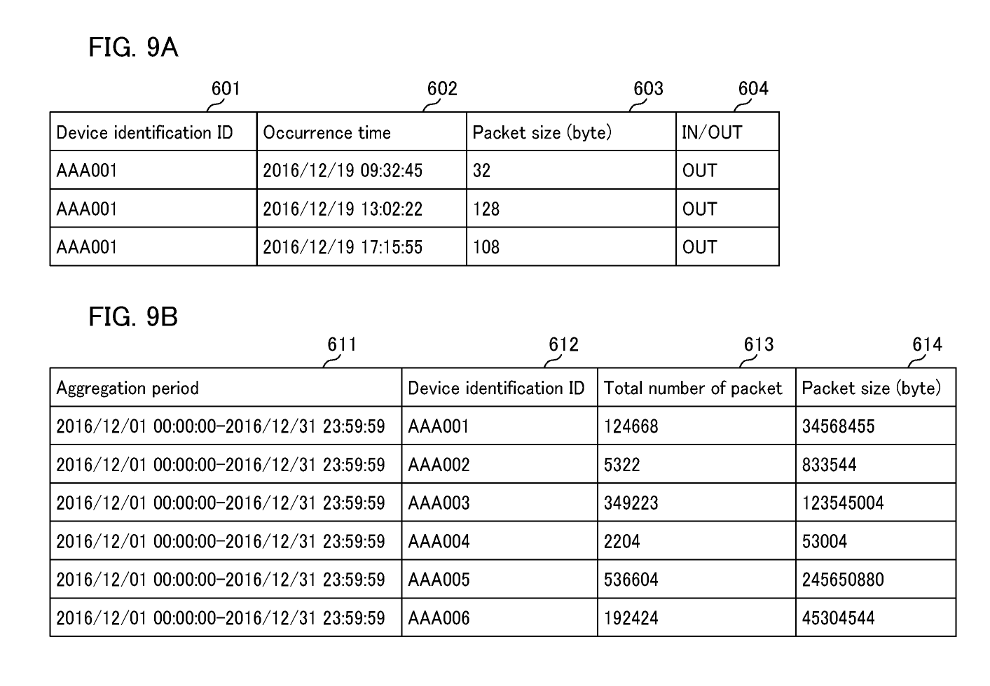

FIGS. 9A and 9B are diagrams illustrating an example of network traffic information of the image forming apparatus.

FIG. 9A shows a collection result of network traffic information. In FIG. 9A, a device identification ID 601 uniquely identifies the image forming apparatus 101 in the system. A device identification ID is, for example, a MAC address or IP address. An occurrence time 602 indicates a time at which a network packet has occurred. A packet size 603 indicates a size of a network packet. An IN/OUT 604 indicates whether a network packet is a packet issued from the image forming apparatus 101 toward the outside or a packet related to an inquiry from the outside.

FIG. 9B shows an aggregation result of network traffic information. An aggregation period 611 is an aggregation period of network traffic information. In an example illustrated in FIG. 9B, the aggregation period 611 shows an aggregation result of network traffic information that has occurred during the month of December 2016. A device identification ID 612 uniquely identifies the image forming apparatus 101 in the system. A total number of packets 613 indicates a total value of the numbers of packets in the aggregation period 611. A packet size 614 indicates a total value of packet sizes in the aggregation period 611.

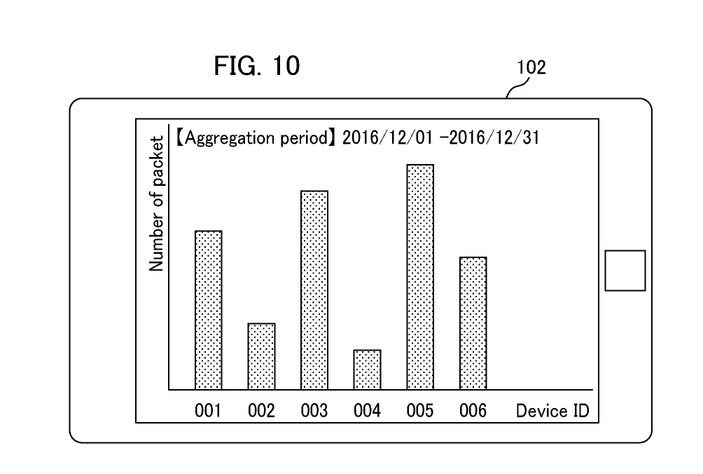

FIG. 10 is an example of a graph display of an aggregation result of network traffic information.

In an example illustrated in FIG. 10, the mobile terminal 102 displays an aggregation result of network traffic information for one month in a graph in which a vertical axis represents the number of packets and a horizontal axis represents a device identification ID.

### <Electric Power Consumption Collection Process>

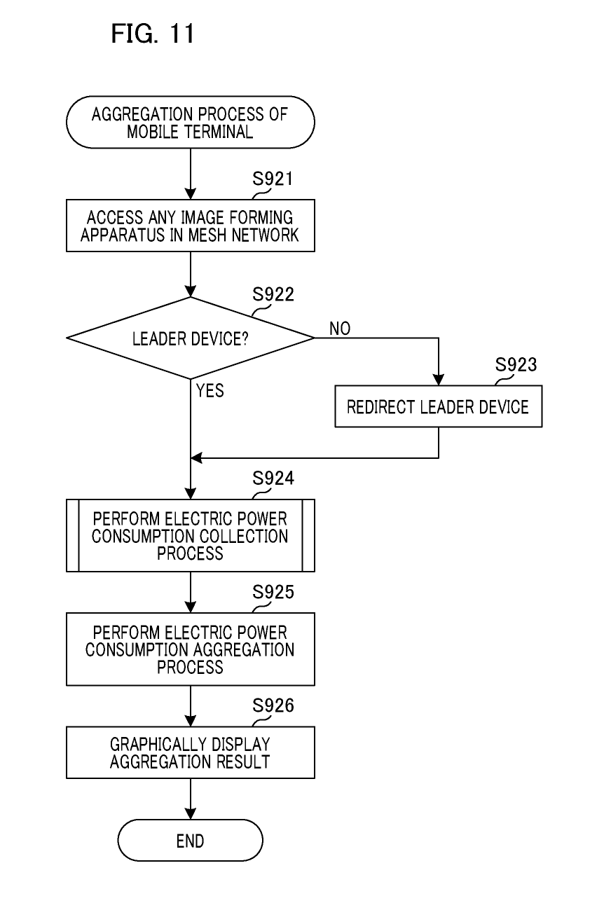

FIG. 11 is a flowchart for describing an electric power consumption collection process and a graph display process of a mesh network using a mobile terminal.

The process illustrated in FIG. 11 is realized using the CPU 250 (FIG. 3A) included in the mobile terminal 102 executing the system software stored in the HDD 255. Processes of S921 to S923 are the same as the processes of S421 to S423 of FIG. 6. In S924, the mobile terminal 102 performs an electric power consumption collection process. Subsequently, in S925, the mobile terminal 102 aggregates network traffic information. Moreover, in S926, the mobile terminal 102 graphically displays an aggregation result on the display unit.

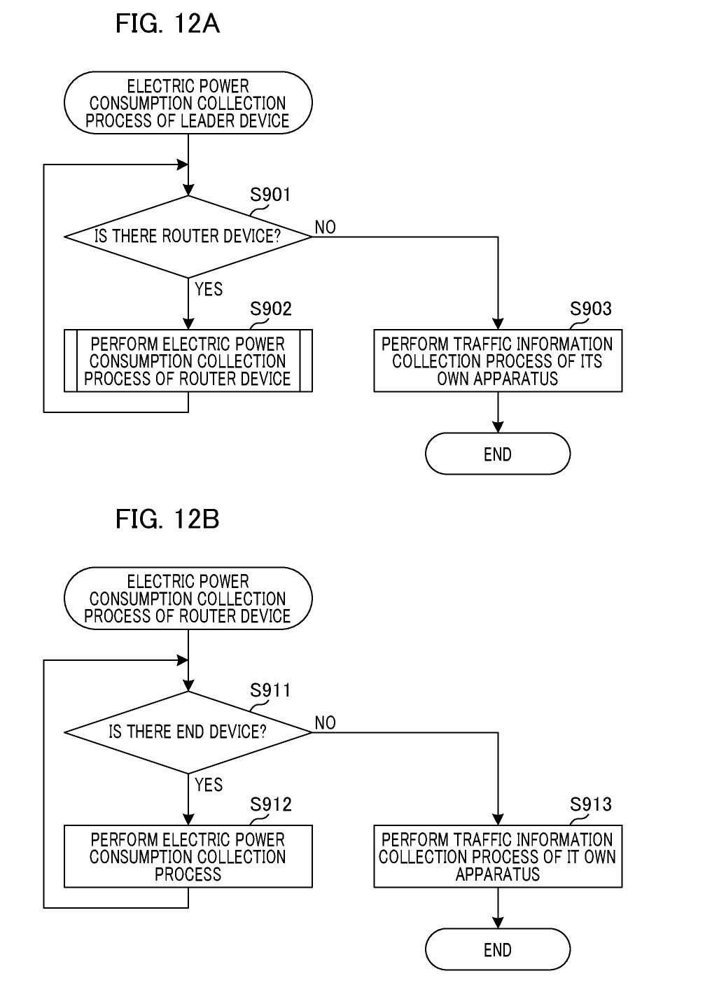

FIGS. 12A and 12B are flowcharts for describing an electric power consumption collection process using a leader device and a router device.

FIG. 12A shows the electric power consumption collection process using the image forming apparatus 101a serving as a leader device. This process is called from the network traffic information collection process of the mesh network using the mobile terminal 102 in S924 of FIG. 11. Furthermore, the program configured to realize this process is stored in the ROM 215 or the HDD unit 216 as the application 308, loaded in the RAM 211 when the image forming apparatus 101 is activated, and executed.

In S901, the application 308 of the image forming apparatus 101a determines whether a router device is in a mesh network group. When it is determined that the router device is in the mesh network group, the process proceeds to a process of S902. When it is determined that the router device is not in the mesh network group, the process proceeds to a process of S903.

In S902, the application 308 collects electric power consumption of the router device. Note that details of the process contents of S902 will be described below with reference to FIG. 12B. When there are a plurality of router devices, the process is repeated for all router devices. Furthermore, in S903, the application 308 collects electric power consumption of the leader device via the smart meter 103. Then, the process ends.

Note that it is assumed that the image forming apparatuses 101 use a wireless network and are caused to be associated with each other via the network I/F 273 when the electrical plug (not shown) is inserted into the power supply unit 277 of the smart meter 103. To be specific, the image forming apparatus 101 stores correspondence information between the device identification ID 601 and an electrical outlet ID (not shown) used for uniquely identifying the smart meter 103 in the HDD 275 of the smart meter 103. It is assumed that data to be collected in the mesh network includes a device identification ID 601, an electrical outlet ID (not shown), and electric power consumption information.

FIG. 12B shows the electric power consumption collection process in the image forming apparatus 101b serving as the router device. In S911, the application 308 of the router device determines whether an end device is in a mesh network group. When it is determined that the end device is in the mesh network group, the process proceeds to a process of S912. When it is determined that the end device is not in the mesh network group, the process proceeds to a process of S913.

In S912, the application 308 collects electric power consumption of the end device. When there are a plurality of end devices, the process is repeated for all end devices. Furthermore, in S913, the application 308 collects electric power consumption of the router device via the smart meter 103 configured to monitor electrical power supplied to its own apparatus. Then, the process ends.

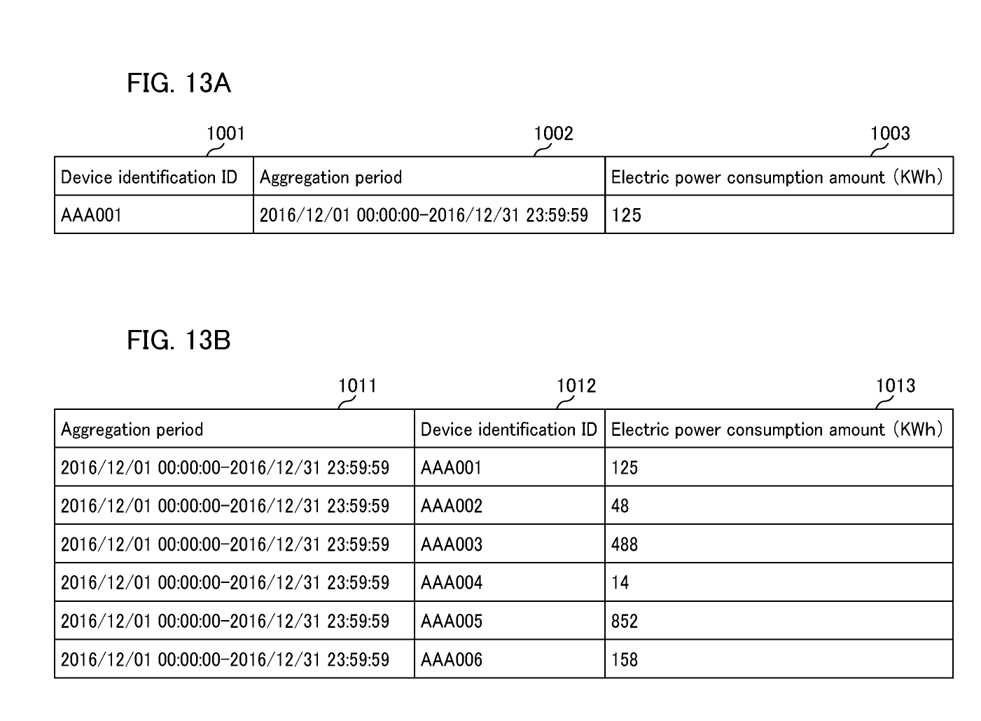

FIGS. 13A and 13B are diagrams illustrating an example of electric power consumption of the image forming apparatus.

FIG. 13A shows a collection result of electric power consumption. In FIG. 13A, a device identification ID 1001 uniquely identifies the image forming apparatus 101 in the system. The device identification ID is, for example, a MAC address or IP address. An aggregation period 1002 is a period in which electric power consumption is measured and aggregated. Electric power consumption 1003 is an amount of electric power consumed during the aggregation period 1002.

FIG. 13B shows an aggregation result of electric power consumption. An aggregation period 1011 indicates an aggregation period of electric power consumption. In an example illustrated in FIG. 13B, the aggregation period 1011 shows an aggregation result of an amount of electric power that has been consumed during the month of December 2016. A device identification ID 1012 uniquely identifies the image forming apparatus 101 in the system. Electric power consumption 1013 indicates a total value of electric power consumption in the aggregation period 1011.

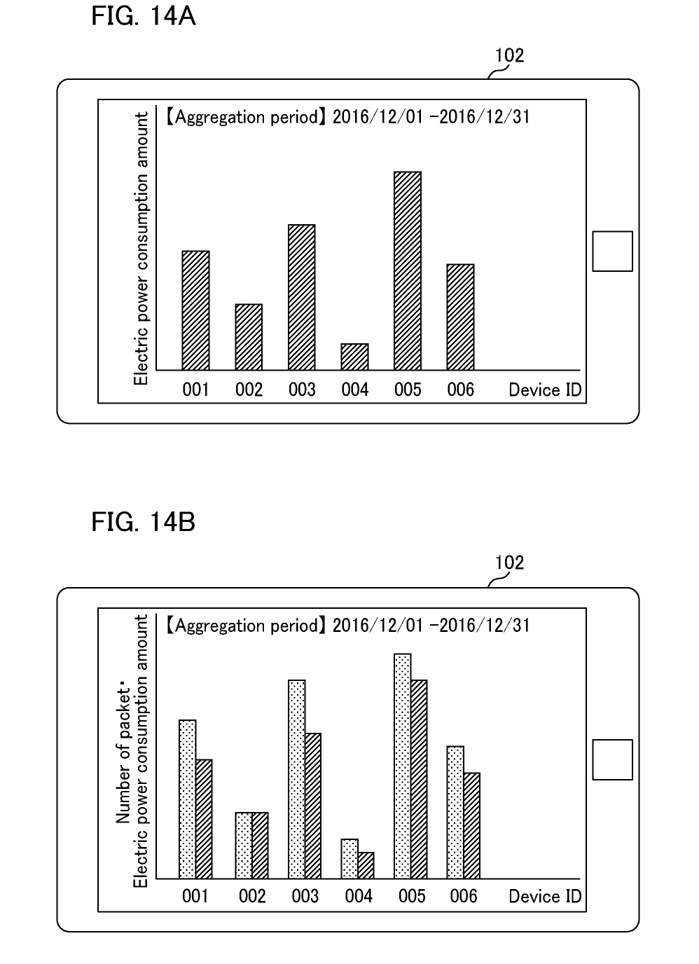

FIGS. 14A and 14B are examples of a graph display of an aggregation result of electric power consumption.

In the example illustrated in FIG. 14A, the mobile terminal 102 displays an aggregation result of network traffic information for one month in a graph in which a vertical axis represents electric power consumption and a horizontal axis represents a device identification ID.

Although an example in which the network traffic information and the electric power consumption are separately aggregated and displayed in the mobile terminal 102 has been described in the first embodiment, as shown in FIG. 14B, the mobile terminal 102 or the external apparatus may simultaneously display both graphs. Furthermore, when only network traffic information can be acquired or only electric power consumption can be acquired depending on the performance or state of the image forming apparatus, the mobile terminal 102 may graphically display only information that can be acquired between the network traffic information and the electric power consumption.

### Modified Example 1

In the management system of the first embodiment, the network traffic information and the electric power consumption are collected in different mesh network groups. As Modified example 1 of the first embodiment, a plurality of types of operational data (for example, network traffic information and electric power consumption) may be collected with the same mesh network group.

### Modified Example 2

A mesh network configured to collect electric power consumption may be constructed to include a group of smart meters 103 configured to manage electric power supply to each image forming apparatus 101. In Modified example 2, each smart meter 103 participates in a mesh network configured to communicate data including electric power consumption using a network I/F 273. As described with reference to FIG. 8, the construction of a mesh network is performed by performing a predetermined initial setting such as applying a mesh group ID.

According to the management system of Modified example 2, information indicating electric power consumption can be collected from a smart meter 103 even when the information indicating electric power consumption cannot be collected from each image forming apparatus 101. Note that, in Modified example 2, data collected via the mesh network includes an electrical outlet ID (not shown) and electric power consumption information used to uniquely identify a device identification ID 601 and the smart meter 103.

### Modified Example 3

In Modified example 3, when network traffic information and electric power consumption are separately aggregated and displayed in the mobile terminal 102, pairing of a smart meter 103 configured to manage electric power supply to each image forming apparatus is managed in advance using a mobile terminal 102. To be specific, the mobile terminal 102 manages pairing of a device identification ID 601 and an electrical outlet ID used to uniquely identify the smart meter 103. Thus, data collected via a mesh network needs only to include identification information of a data transmission source (the device identification ID 601 or the electrical outlet ID) and target data (traffic information or electric power consumption).

According to the management system of the first embodiment described above, a plurality of pieces of network traffic information and electric power consumption can be collected via the mesh network. Therefore, it becomes possible to ascertain a use situation of a plurality of image forming apparatuses without constructing a dedicated server for a local area network (LAN) environment in an office. For example, when there is a device having a large amount of network traffic and a small amount of electric power consumption, usage of functions unique to a device (for example, a printing function) is relatively small, but it can be analyzed that unique use such as frequent use of a network is done.

### Second Embodiment

In the first embodiment, a value measured by a smart meter 103 is used as it is as electric power consumption of an image forming apparatus 101. However, since amounts of electric power consumed are different depending on capability of an image forming apparatus, an operating state is likely to not being accurately expressed through only simple electric power consumption comparison. In the management system according to the second embodiment, a typical electricity consumption (TEC) value is applied. The TEC value is a standard trial value of electric power consumption in one week. A period that is normally used in an office, specifically, five days in which an operation, a sleep state, or a power off state are repeated and two days in which a sleep state and a power off state are performed is set. The TEC value is an amount of electric power consumed in the above-described set period. The management system can ascertain/display the operating state of the image forming apparatus 101 with high accuracy, for example, by comparing values obtained by dividing the electric power consumption collected for one week by the TEC value.

The present invention may be applied to a system constituted of a plurality of devices or to an apparatus constituted of a single device. The present invention is not limited to the above-described embodiments, but various modifications (including organic combinations of the embodiments) are possible on the basis of the gist of the present invention. In addition, the various modifications (including organic combinations of the embodiments) are not excluded from the scope of the present invention. In other words, all configurations in which the above-described embodiments and modifications thereof are combined are also included in the present invention.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-028804, filed Feb. 20, 2017, which is hereby incorporated by reference wherein in its entirety.

What is claimed is:

1. A management system that includes one or more electronic apparatuses connected to a predetermined network and an information processing apparatus configured to collect operational data concerning each of the electronic apparatuses,
wherein the information processing apparatus comprises a first memory storing instructions and a first processor which is capable of executing the instructions in the first memory causing the client apparatus to:
request acquisition of operational data from the electronic apparatus functioning as a node device of a mesh network different from the predetermined network via the mesh network; and
collect operational data of a node device transmitted in response to the request.

2. The management system according to claim 1, wherein the electronic apparatus functioning as the node device comprises a second memory storing instructions and a second processor which is capable of executing the instructions in the second memory causing the electronic apparatus to perform a process of constructing a mesh group using a predesignated group ID, and
wherein the group ID differs for each type of object data to be collected or for each type of a node device.

3. The management system according to claim 1, wherein the electronic apparatus functioning as the node device comprises a second memory storing instructions and a second processor which is capable of executing the instructions in the second memory causing the electronic apparatus to perform a process of constructing a mesh group using a predesignated group ID), and
wherein the instructions in the first memory further cause the information processing apparatus to collect a plurality of types of operational data from electronic apparatuses of the same mesh group.

4. The management system according to claim 1, wherein the instructions in the first memory further cause the information processing apparatus to collect at least network traffic information or electric power consumption information in the electronic apparatus functioning as the node device as the operational data.

5. The management system according to claim 1, wherein the instructions in the first memory further cause the information processing apparatus to aggregate the collected operational data.

6. The management system according to claim 1, wherein the electronic apparatus includes an image processing apparatus or a power supply management apparatus configured to manage electric power supplied to the image processing apparatus.

7. The management system according to claim 1, wherein the information processing apparatus functions as a part of the electronic apparatus.

8. The management system according to claim 1, wherein the instructions in the first memory further cause the information processing apparatus to collect operational data of a second electronic apparatus present at a lower-ordered node than a first electronic apparatus in the mesh network via the first electronic apparatus.

9. The management system according to claim 8, wherein, if the second electronic apparatus present at the lower-ordered node than the first electronic apparatus is not connected to the mesh network, the instructions in the second memory further cause the first electronic apparatus to collect electric power consumption information of the first electronic apparatus via a power supply management apparatus configured to manage electric power supplied to the first electronic apparatus.

10. A management method in a system including one or more electronic apparatuses connected to a predetermined network and an information processing apparatus configured to collect operational data concerning each of the electronic apparatuses, the management method comprising:
requesting, by the information processing apparatus, acquisition of operational data from the electronic apparatus functioning as a node device of a mesh network different from the predetermined network via the mesh network; and
collecting, by the information processing apparatus, operational data of a node device transmitted in response to the request.
